(19) United States
(12) Patent Application Publication
(10) Pub. No.: US 2009/0201198 A1
(43) Pub. Date: Aug. 13, 2009

(54) System and method for delivery of goods ordered via the internet

(76) Inventor: Christopher Moudy, Costa Mesa, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/379,771

(22) Filed: Feb. 27, 2009

Related U.S. Application Data
(63) Continuation-in-part of application No. 11/004,075, filed on Dec. 6, 2004.

(51) Int. Cl. G06Q 10/00; A47B 96/00; G01S 1/08; G08C 19/00

(52) U.S. Cl. 342/357.06; 705/1; 312/326; 340/5.51

(57) ABSTRACT

The system and method for delivery of goods ordered via the Internet utilizes a delivery box having a front door with an electronic lock and electronic key reader for receipt of goods ordered via the Internet. Goods are shipped in a transport box having an interior space and a device for controlling the temperature within the interior space. The delivery box has at least one interior transport box receptacle where a transport box containing goods is placed on delivery. A power and data interface is established between a delivery box control circuit and a transport box control circuit the transport box is placed into one of the receptacles, so that the delivery box control circuit can power the transport box control circuit and environment controlling device. A security code is downloaded from an Internet merchant site to the delivery box, and stored onto a keycard, when an order is placed.

### CROSS-REFERENCE TO RELATED APPLICATIONS

This application is a continuation-in-part of U.S. patent application Ser. No. 11/004,075, filed Dec. 6, 2004.

### BACKGROUND OF THE INVENTION

1. Field of the Invention

The present invention relates to the delivery of goods purchased via Internet-based electronic commerce and, more particularly, to a system and method for delivery of goods ordered via the Internet.

2. Description of the Related Art

The Internet has opened a vast electronic frontier for consumers, enabling the consumers to shop, from the convenience and comfort of their own home or business, among countless providers of all types of goods. Electronic commerce, merged with the Internet and the World Wide Web, facilitates the purchase of goods by integrating a variety of payment services so that, after browsing the Web and browsing merchant websites, goods may be purchased essentially with the click of a button.

Once an order for goods has been placed with an Internet merchant, the goods of course must be delivered to the customer. While conventional forms of delivery, including the U.S. mail, express and overnight delivery services and other forms of mail and package delivery, and other common delivery and shipping methods and services, suffice for many items ordered on the Internet, some items require special handling for proper delivery. Food or other perishable items may require special care, such as maintenance of proper temperatures during delivery and after delivery if the food items delivered are left unattended. High value items may require special handling for security, or will require insurance against the loss or theft of the items during the course of delivery. The lack of a delivery service specialized to accommodate special handling for some goods may discourage a vibrant Internet marketplace for the goods if customers are concerned about receiving goods in good condition (such as frozen food items that may arrive thawed) or if Internet merchants or their customers must bear excessive costs to insure goods for delivery. Additionally, delivery of some goods is hampered if the recipient is not present to receive the goods, since shippers and merchants are reluctant to have certain goods left unattended.

Various receptacles have been employed to receive delivered goods. A locked mailbox, for example, with a delivery slot that allows letters or very small packages to be inserted into the mailbox, and only removed by a recipient with a key. This provides a degree of security for the letters and small packages, but does not prevent receipt of unwanted items. Additionally, provision for maintaining an environmental condition is lacking. Larger lock boxes have been devised to overcome package size limitations. However, no known lock box addresses all phases of delivery of goods to provide security and proper handling of goods with special needs.

Thus, a system and method for delivery of goods ordered via the Internet solving the aforementioned problems is desired.

### SUMMARY OF THE INVENTION

The system and method for delivery of goods ordered via the Internet employs a delivery box for receiving goods ordered via the Internet, and transport boxes for delivery of goods requiring special handling during delivery. The delivery box has at least one inner bay for receiving a transport box containing delivered goods. The transport box may include means for providing for special handling requirements of goods, such as a lock that interacts with the delivery box such that the transport box may only be opened upon delivery or by an authorized delivery person, or means for maintaining an environmental parameter, such as a cold or a warm temperature, for proper storage during delivery of goods that have particular environmental needs.

The delivery box has at least one secure door for access to the interior of the delivery box, and may have a second door for access in a pass-through fashion. In one embodiment, the delivery box is configured for through-wall mounting, having a secure outside door and an inside door such that goods are delivered into the delivery box through the secure outside door, and are removed by the customer through the inside door.

Access through the secure door is controlled by an electronic lock, in conjunction with a user key interface that may be a keycard reader, an electronic cipher lock, a radio frequency identification (RFID) key reader, or another similar electronic lock and key arrangement. To gain access into the delivery box, a delivery person must therefore have an appropriately matching coded key, or must know a correct cipher lock code. A unique code is assigned for each delivery, helping to ensure that access to the delivery box is only obtained by a delivery person making an expected delivery, and facilitating tracking of the order.

The delivery box is in communication with the Internet, such that when a customer places an order to purchase goods using the Internet, a unique delivery code associated with the purchase order is created, and delivered both to the delivery box and with the purchase order to the Internet merchant, the delivery code being encrypted for security. Along with the delivery code, delivery instructions are generated that include an identification number or code for the destination delivery box, time and place for delivery, handling instructions (such as a requirement to keep frozen foods cold) and security instructions. The ordered goods are placed into a transport box that is configured according to the delivery instructions, such as providing a transport box with refrigerating capability for frozen foods. Delivery instructions may be downloaded to the transport box and the delivery box, for example, to set a holding temperature to maintain the goods or to deliver GPS coordinates for the delivery location.

The Internet merchant provides to a delivery person or service means for accessing the customer's delivery box, by providing a programmable keycard or other electronic key device, or providing a cipher lock code, or the like. Delivery access code information may be provided, via a secure server, over the Internet from the Internet merchant, who produces the corresponding keycard at the time of paid order confirmation, to the delivery service. The electronic key device bearing the access code is used upon delivery, and may be left with the delivered goods as a receipt.

On delivery of the goods to the delivery site, a delivery person uses the electronic key device to gain access into the delivery box, placing the goods into the delivery box. A transport box may interact with the delivery box to perform security functions, or to receive power from the delivery box to ensure continuation of environmental parameters or other settings maintained by the transport box. The transport box, equipped with a GPS, may compare the actual location with the expected delivery location to verify that the goods have been properly delivered. A mismatch causes an alarm, such as illuminating an indicator light or generating a service warning. In the case of high value goods, a mismatch may disable a lock on the transport box, preventing access to the goods within. This serves both to enhance security of deliveries of high value goods, and to prevent accidental erroneous deliveries when a delivery person, carrying multiple transport boxes, places the wrong transport box into a delivery box.

On receipt of goods, the delivery box creates a signal to alert the customer that the goods have arrived, and creates and forwards a tracking confirmation to the Internet merchant.

These and other features of the present invention will become readily apparent upon further review of the following specification and drawings.

### BRIEF DESCRIPTION OF THE DRAWINGS

FIG. 1 is an environmental, perspective view of a delivery box for a system and method for delivery of goods ordered via the Internet according to the present invention.

FIG. 2 is a front view of the delivery box illustrated in FIG. 1, showing a keycard reader on the front door of the delivery box.

FIG. 3 is a side view of the delivery box illustrated in FIG. 1, shown mounted through a wall for pass-through access.

FIG. 4 is a bottom/front perspective view of a transport box used with the delivery box illustrated in FIG. 1.

FIG. 5 is a block diagram of electronic components of a delivery box in communication with a transport box.

FIG. 6 is a block diagram of a system for delivery of goods ordered via the Internet according to the present invention.

FIG. 7 is a flowchart of a process for Internet purchase order entry in a method for delivery of goods ordered via the Internet according to the present invention.

FIG. 8 is a flowchart of a process for order fulfillment in a method for delivery of goods ordered via the Internet according to the present invention.

FIG. 9 is a flowchart of a process for order receipt at a delivery box in a method for delivery of goods ordered via the Internet according to the present invention.

FIG. 10 is a flowchart of a process for customer receipt of an order in a method for delivery of goods ordered via the Internet according to the present invention.

Similar reference characters denote corresponding features consistently throughout the attached drawings.

### DETAILED DESCRIPTION OF THE PREFERRED EMBODIMENTS

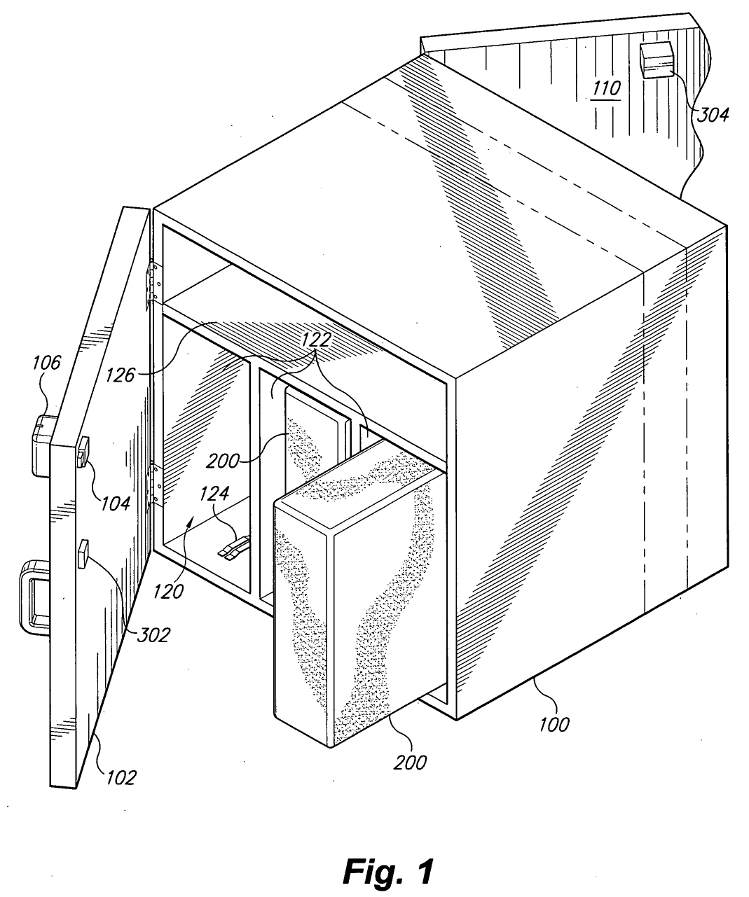

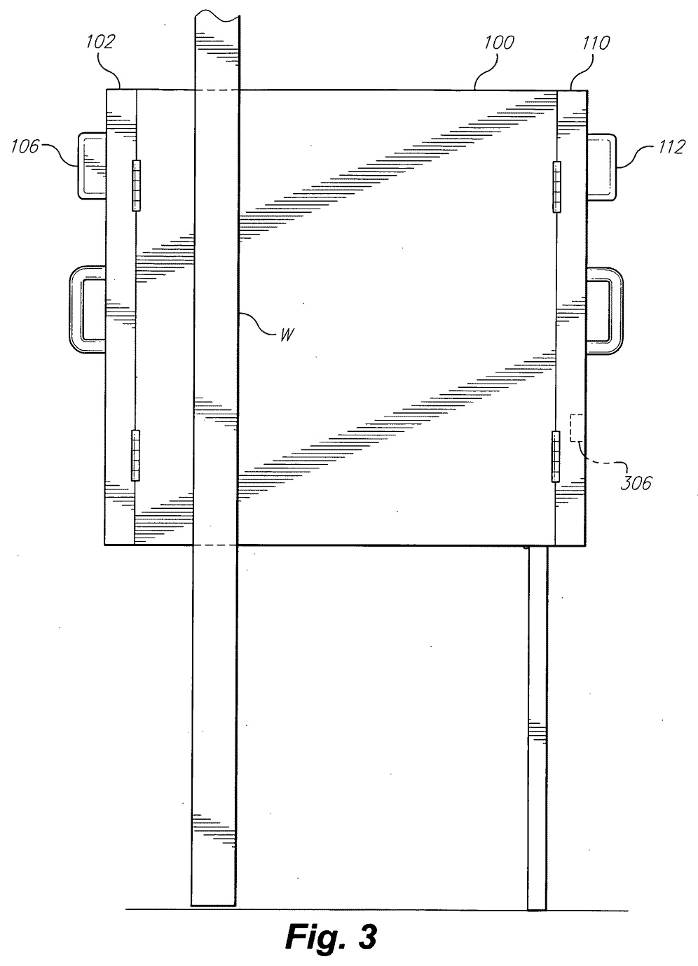

The present invention is a system and method for delivery of goods ordered via the Internet. Referring to FIGS. 1-3, a system for delivery of goods ordered via the Internet employs a delivery box 100 having a front door 102 securable by an electronic lock 104 for access to a large interior space 120. In the illustrated embodiment, the electronic lock 104 includes a keycard reader 106, such as a magnetic strip card reader or the like, for reading a keycard 105 to gain entry to the interior space 120. The delivery box 100 may be embodied in a stand-alone configuration, having only the front door 102 for access, or in a wall-mounted pass-through configuration as illustrated, seen mounted through a wall W in FIG. 3, having additionally a second door 110 for access to the interior space 120 of the delivery box 100. The delivery box 100, especially in the stand-alone configuration, may be used for mobile applications as well as at a fixed location. The second door 110 may include a lock 112 for security, such as a key lock or an electronic cipher lock so that access to the interior space 120 can controlled through both the front door 102 and the second door 110. The delivery box 100 has a controller circuit 150 in communication with the locks 104 and 112, to manage access codes and access to the interior space 120 of the delivery box 100.

The interior space 120 of the delivery box 100 is divided into smaller spaces, including one or more transport box receptacles 122 adapted to receive goods packaged in a transport box 200. At least one additional space 126 is provided for receiving goods not packaged in a transport box 200. Each transport box receptacle 122 includes electrical contacts 124 disposed therein to provide electrical power to matching contacts on a transport box 200, the electrical power powering a refrigerating, heating, or other device contained within the transport box 200. Additionally, electrical contacts may provide for a data communication between the controller circuit 150, of the delivery box 100, and a controller circuit 250 contained in the transport box 200. Alternatively, a wireless method of communication may be used for communication between the controller circuit 150 of the delivery box 100 and the controller circuit 250 contained in the transport box 200.

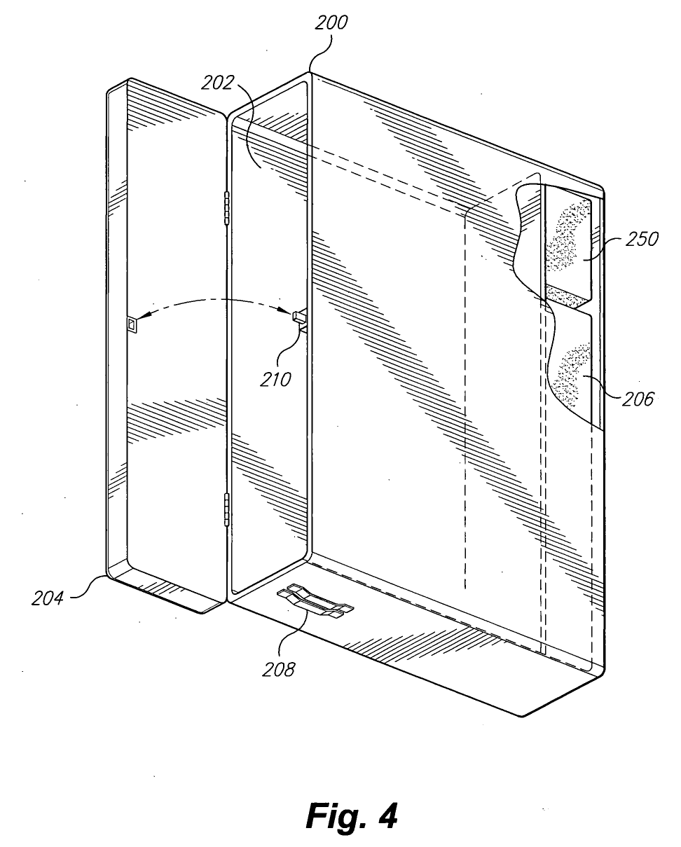

Turning now to FIG. 4, a transport box 200 is shown in greater detail. A transport box 200 is a container having an interior space 202 for receiving goods for transport or shipment. A hinged or removable cover 204 allows access to the interior space 202. The transport box 200 includes environment control means 206 for controlling the environment within the interior space, such as a resistance or other type of heating device, a Peltier thermoelectric device for heating and cooling, a miniaturized Stirling cycle cooler, or other devices for providing heating and or cooling to the interior space 202. Note that, in some embodiments, a passive means for maintaining heat or cold, such as an ice pack, may be used.

In the illustrated embodiment, a control circuit 250 is in communication with the environment control means 206 and operates the environment control means 206 to maintain a predetermined environment within the interior space 202. Electrical contacts 208 on the outside of the transport box 200 are adapted for engagement with the electrical contacts 124 in a transport box receptacle 122 within a delivery box 100. An electronic locking mechanism 210 may be provided in communication with the control circuit 250, whereby the transport box 200 may be locked until unlocked by the control circuit 250, such as when the control circuit recognizes that the transport box 200 has been placed within a transport box receptacle 122 within a delivery box 100.

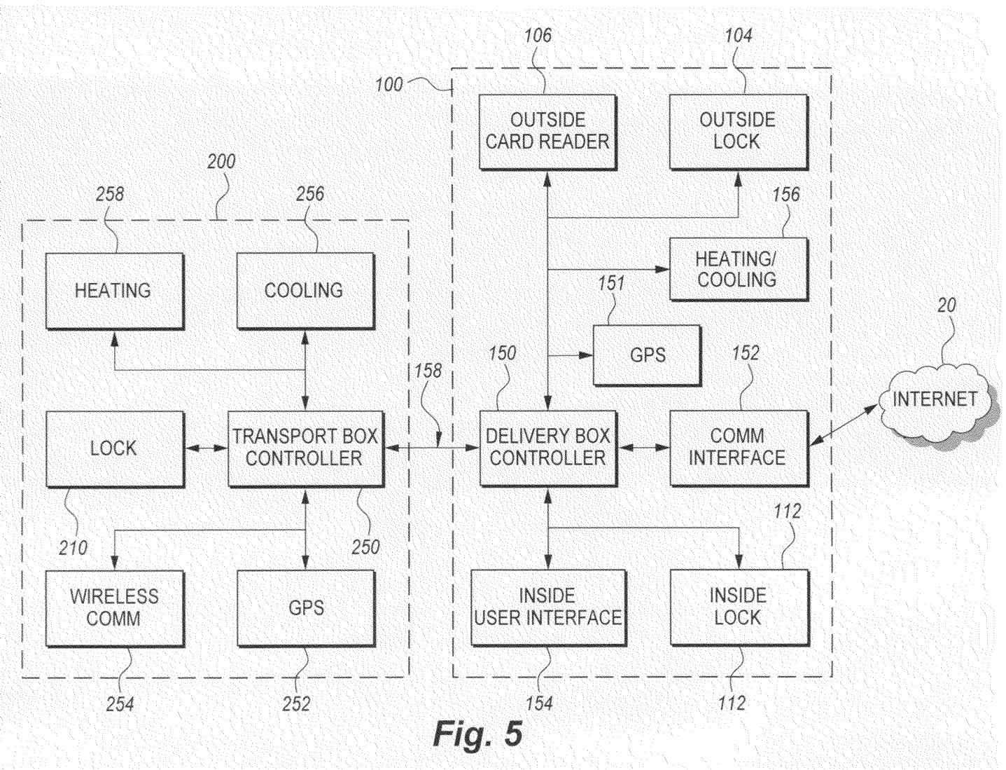

Turning now to FIG. 5, a block diagram illustrates the relationship between the various electrical components of a delivery box 100, and a transport box 200 placed within transport box receptacle 122 of the delivery box 100. On placement of the transport box 200 into a transport box receptacle 122 within the delivery box 100, a communication interface 158 is established between the delivery box 100 control circuit 150 and the transport box 200 control circuit 250. The control circuit 150 and the control circuit 250 communicate across the electrical contacts 124 in connection with electrical contacts 208. A wireless interface is established between control circuit 150 and control circuit 250 in an alternate embodiment.

The delivery box 100 control circuit 150 is in communication, via a communication interface 152, with the Internet 20. The communication interface 152 may employ a wireless technology for remote communication. The control circuit 150 is also in communication with the card reader 106 and the electronic lock 104, reading a security code from an electronic keycard 105 swiped through, or inserted into, the card reader 106 and activating the electronic lock 104 according to a valid or an invalid security code. Similarly, if the lock 112 on the second door 110 of the delivery box 100 is an electronic lock, the control circuit 150 may be in communication with lock 112, and, optionally, a user interface 154 such as a keypad or electronic key reader or the like for controlling or recording user access to the delivery box.

The control circuit 150 also includes a Global Positioning System (GPS) receiver 151. The GPS receiver 151 is used to determine the location of the delivery box 100 for delivery purposes. In a mobile application, or for a fixed location application where the location of the delivery box 100 is not well described by a street address or other means, the GPS coordinates of the location of the delivery box 100 are used instead of an address to identify the location of the delivery box 100 for deliveries.

The control circuit 150 may also operate a heating and/or cooling device 156 disposed within an interior space of the delivery box 100. The control circuit 150 preferably includes a microcomputer or microcontroller, or other type of programmable logic device, and a memory for storing programming instructions.

The transport box 200 control circuit 250 of the illustrated embodiment includes a Global Positioning System (GPS) receiver 252, and a wireless communications interface 254 such as Bluetooth, wireless Ethernet (802.11b) or a similar technology. The control circuit 250 is in communication with the electronic locking mechanism 210, and with the environment control means 206 comprising a heating 258 and/or a cooling device 256. The control circuit 250 preferably includes a microcomputer or microcontroller, or other type of programmable logic device, and a memory for storing programming instructions.

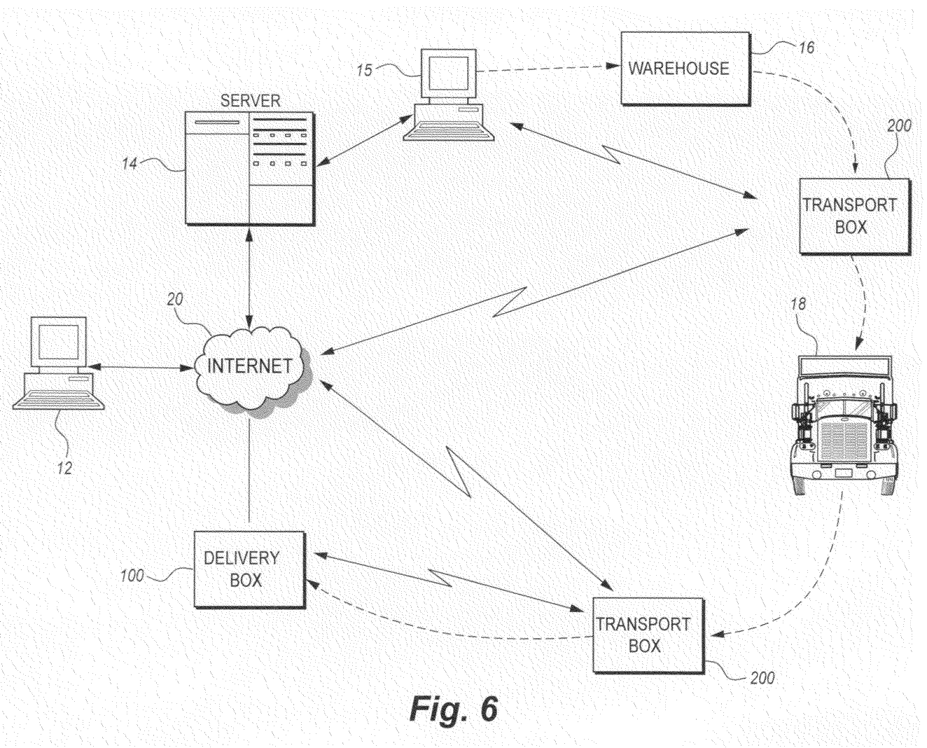

Turning now to FIG. 6, a system for delivery of goods ordered via the Internet is illustrated employing a delivery box 100 in communication with the Internet 20. A customer using a customer computer 12 to access the Internet 20 browses the World Wide Web seeking an Internet merchant of desired goods, and places an order for delivery of goods to the customer's delivery box 100. An Internet merchant server 14 in communication with the Internet 20 receives a customer order for goods, along with delivery instructions for the goods, and dispatches the order for fulfillment to a warehouse 16, such as by way of vendor or warehouse computer 15 in communication with the server 14 via the Internet 20. An identification or security code is generated for the order, and a keycard is created bearing code in an electronically readable format. The goods are packaged into a transport box 200, and electronic delivery instructions downloaded into the control circuit 250 of the transport box 200, along with the keycard. A shipping or transportation company 18 delivers the transport box 200 to the customer's delivery box 100, using the keycard to open the delivery box 100, whereupon the transport box 200 is placed into a transport box receptacle 122 within the delivery box 100 for access by the customer.

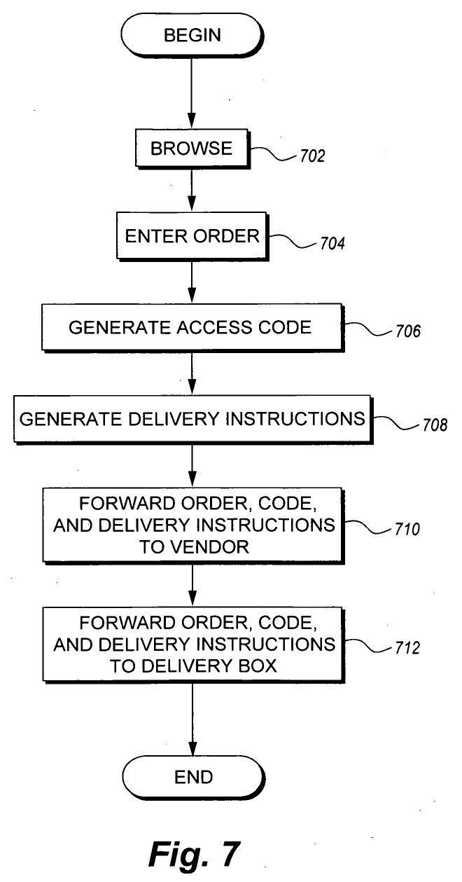

Turning now to FIGS. 7-10, a method for delivery of goods ordered via the Internet is described, the method employing a delivery box 100, a transport box 200, and the system briefly described in FIG. 6. The method may be embodied in a computer program executing on an Internet merchant server 14, and in programming of the control circuit 150 in the delivery box and programming of the control circuit 250 of the transport box 200. In such an embodiment, the computer program generally functions as a Web service to provide customer interface functions to a client program such as an Internet browser functioning on a customer computer 12.

A method for entering an order by a customer is described in FIG. 7. A customer begins the process by browsing the Internet 20, and particularly a merchant Web site, to locate goods for purchase (step 702). With goods selected, an order is entered (step 704), identifying a delivery address for the customer, or the location of the delivery box 100 indicated by the GPS 151, and identifying the customer's delivery box 100. The order entry includes completion of a payment transaction, wherein the customer enters payment information such as a credit card number or appropriate identification for another online payment service.

Once the order is entered, and payment confirmed, a unique delivery or access code is generated (step 706), and a keycard 105 is generated containing the delivery or access code. The delivery code will function as a security code for delivery access to the delivery box 100, and also may be used to track the order. Note that separate security and tracking codes may be used. Codes are preferably encrypted for distribution, over the Internet, to the merchant and the delivery box 100. Delivery instructions are then generated (step 708). The delivery instructions may include electronic delivery instructions that are downloadable into the delivery box 100 and into a transport box 200, identifying special handling for the goods that will be supported by the delivery box 100 and transport box 200.

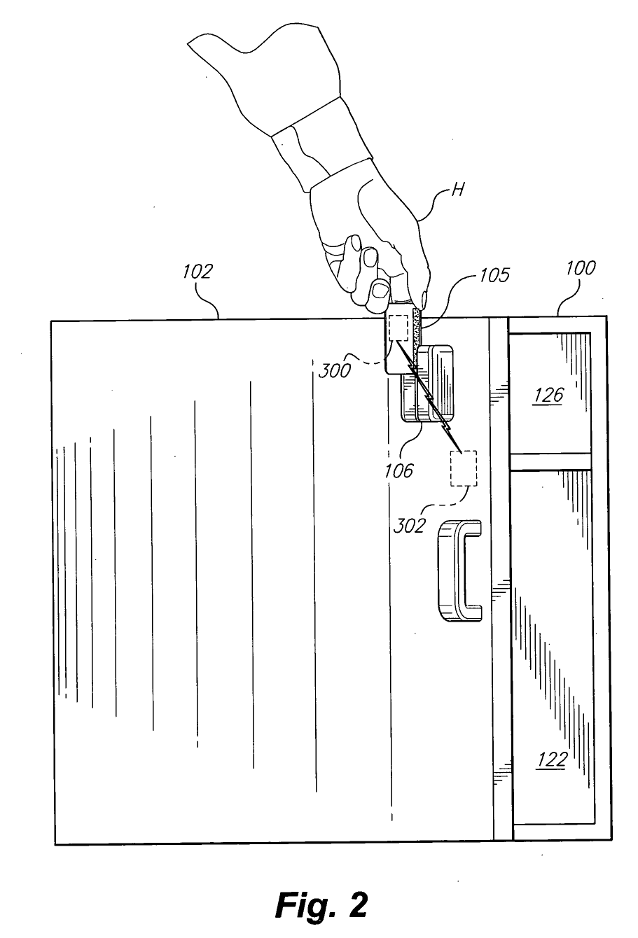

In the above, additional security may be provided by the usage of additional wireless or hardwired sensors. As shown in FIG. 1 and FIG. 2, a wireless tag, such as a radio frequency ID (RFID) chip 300 may be embedded within keycard 105. Alternatively, such a wireless tag may be carried by the delivery person. RFID chip 300 (or any other wireless transmitter) includes either the same access code or a secondary access code, which is transmitted and received by a wireless sensor 302, mounted on the interior of door 102, or mounted in any other suitable location within the system. In order to access the interior, the delivery person needs to swipe the keycard 105, which has the proper access code encoded thereon, and also have the wireless tag 300. Alternatively, a wired system may be utilized. Sensor 302 is in communication with controller 250.

Additionally, a similar sensor 304 (as shown in FIG. 1) may be mounted on the interior side of the system, requiring the interior, household user to also have an encoded wireless tag. Further, as shown in FIG. 3, a computer port 306, such as a USB port or the like, may be incorporated in the internal door 110, with sensor 304 and USB port 306 also being in communication with controller 250. In order to access the interior, the user needs to have the properly encoded wireless tag, along with a portable device or computer, also having an encrypted code stored thereon, which is transmitted to controller 250 via port 306. It should be understood that any suitable type of sensor may be utilized, and any suitable type of computer interface may also be utilized. The wireless sensors and USB port shown in the Figures are shown for exemplary purposes only.

The electronic delivery instructions include temperature or environmental parameters that will be maintained by the delivery box 100 and transport box 200, and may also include security instructions such as a geographic area or GPS location where delivery is to occur. The delivery instructions may also include a due date or time, or an expiration time for the order. The order, security code, and delivery instructions are forwarded to the merchant or a warehouse facility 16 for fulfillment of the order (step 710), and are forwarded to the customer's delivery box 100 (step 712).

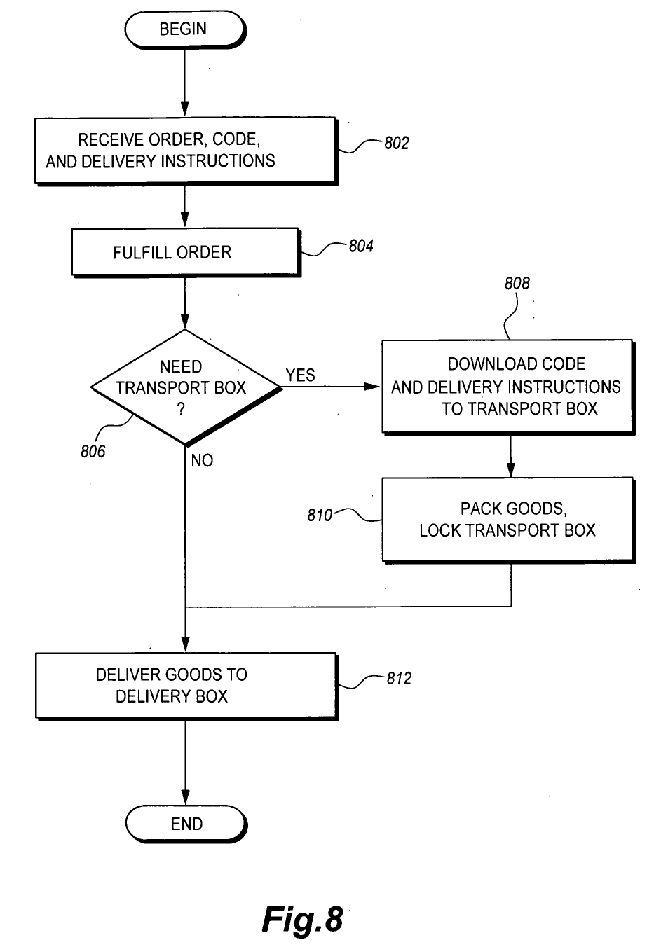

A method for fulfilling an order at a merchant or warehouse facility 16 is described in FIG. 8. The order, security code, and delivery instructions are received by the merchant or warehouse facility (step 802). The order is fulfilled (step 804) by identifying the ordered goods, and preparing them for shipment. With reference to the order and delivery instructions, the merchant or warehouse facility determines if a transport box 200 will be needed for delivery of the goods (step 806). If the goods require a controlled environment or temperature during shipping, or if the delivery instructions require special security for the goods, a transport box 200 is used. The transport box 200 is prepared by downloading the security code and delivery instructions to the transport box 200, the delivery instructions being stored within the control circuit 250 of the transport box 200 (step 810). The goods are then delivered to the customer's delivery box 100 (step 812).

During the course of transport for delivery, the transport box 200 maintains a proper temperature for holding the goods. Additionally, the transport box 200 control circuit 250 may monitor the GPS 252 to determine if the transport box 200 has been transported outside of a pre-determined geographic area, indicated in the delivery instructions, such that the transport box 200 may have been stolen, misrouted, or mishandled. An alert may be forwarded by the transport box 200, by wireless connection to the Internet, to the merchant, shipper, or customer.

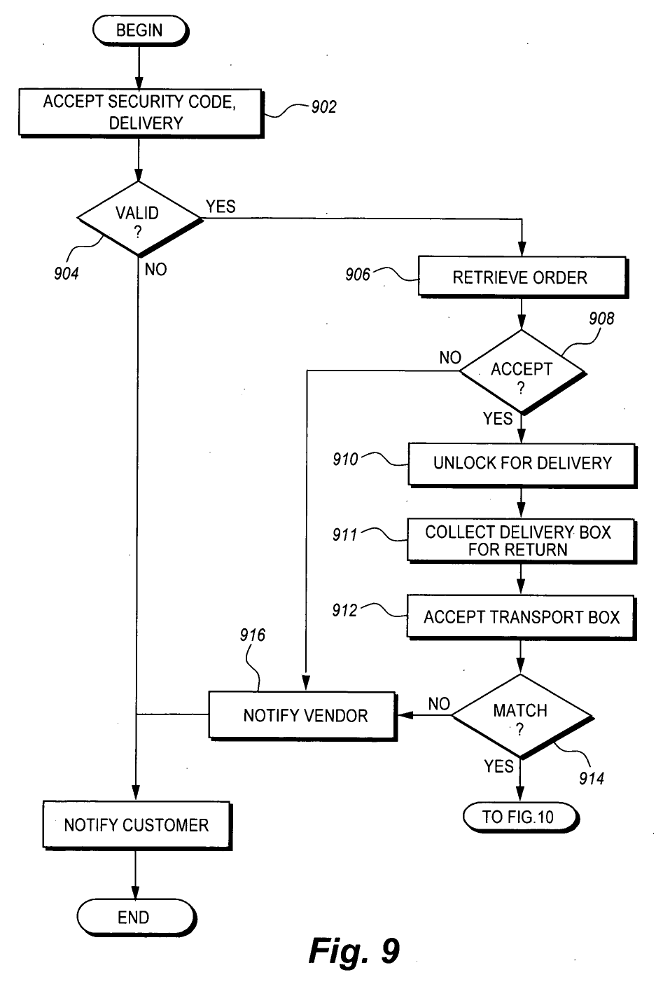

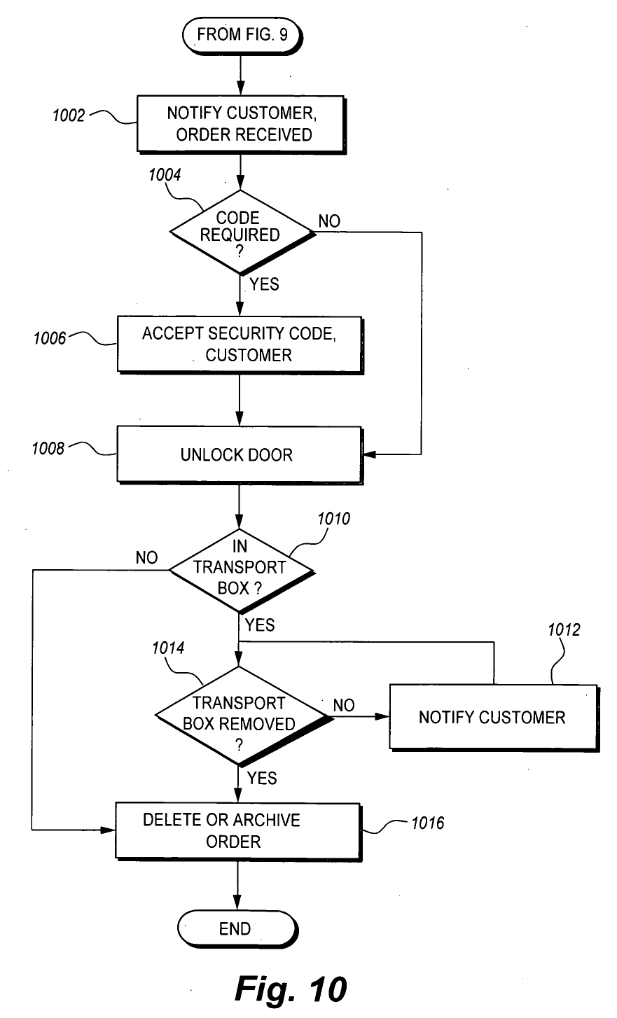

Turning now to FIGS. 9 and 10, a method for delivering goods to the customer's delivery box 100, and subsequently to the customer, is described. When a delivery person arrives at the customer's delivery box 100, a security code must be entered for access to the interior space 120 of the delivery box 100. In the illustrated embodiment, a keycard 105, carrying a security code in a computer readable format, is swiped through the card reader 106, whereupon the control circuit 150 reads the security code (step 902). If the code read is not a valid code (checked at 904), the control circuit 150 does not activate the electronic lock 104 for access to the interior space 120 of the delivery box 100. Instead, a notification may be made to alert the customer that an unauthorized or unexpected attempt to open the delivery box 100 was made (step 918).

If a valid security code is read, an order stored by the control circuit 150 is retrieved (step 906) along with the delivery instructions for the order. The order may be accepted or rejected (at 908) depending on whether or not the delivery of goods complies with the delivery instructions. For example, delivery instructions for an order may have specified a delivery deadline that has been missed. If the order is rejected, a notification is sent to the vendor (or shipper) (step 916), and the customer may be notified (at 918). If the order is accepted, the control circuit 150 commands the electronic lock 104 to open (step 910), allowing access to the interior space 120 of the delivery box 100. On entry to the delivery box 100, the delivery person may find an old transport box 200 left over from a previous delivery, in which case the old transport box 200 is removed for return to the merchant or shipper (step 911). If the delivered goods are packaged in a transport box 200, the transport box 200 is placed into a transport box receptacle 122 (step 912) within the delivery box 100, whereupon the electrical contacts 208 on the transport box 200 are brought into contact with the electrical contacts 124 of the transport box receptacle 122. Goods delivered without a transport box 200 are placed in an additional space 126 within the delivery box 100.

With a transport box 200 placed into a transport box receptacle 122, the control circuit 250 of the transport box 200 communicates with the control circuit 150 of the delivery box 100. The order and delivery instructions stored in the transport box 200 are compared against the order and delivery instructions stored in the delivery box 100, to verify that the correct order has been received. If there is a mismatch (decided at step 914), for example when a delivery person has opened the delivery box 100 with the correct keycard 105 but placed a wrong transport box 200 inside by mistake, an alert is issued, and the vendor may be notified (at 916) and the customer may be notified (at 918).

Continuing on FIG. 10, once the order is completed with goods placed into the delivery box 100, the control circuit 150 of the delivery box 100 may cause an alert to notify the customer of the delivery of the goods (step 1002). In some configurations, the customer will be required to enter a security code to gain access to the goods within the delivery box 100. In a delivery box 100 having only front door 102 for access, for example, the customer will need to enter a code to unlock the door. Similarly, if a second door 110 is configured with an electronic lock such as electronic cipher lock 112, a security code may be required for the customer to gain entry. If a security code is required (at step 1004), the customer enters the code and the control circuit 150 of the delivery box 100 reads the security code. If a valid code is entered, the control circuit 150 allows the customer to open a door for removal of the goods. If the goods are not in a transport box 200, the order and delivery instructions may be deleted or archived (step 1016) once a door is open for delivery. If the goods are contained within a transport box 200, the order and delivery instructions may be retained until the transport box 200 is removed from its transport box receptacle 122. If the transport box 200 is not timely removed from the transport box receptacle 122 after the delivery box 100 is opened by the customer (determined at 1014), a reminder may be generated to notify the customer (step 1012). Once the transport box is removed, the order and delivery instructions may be deleted or archived (step 1016).

It is to be understood that the present invention is not limited to the embodiments described above, but encompasses any and all embodiments within the scope of the following claims.

I claim:

1. A system for delivery of goods in a transport box ordered via the Internet, comprising:
at least one transport box having a door, an interior space, and environment controlling means for controlling the temperature within the interior space, wherein said transport box further comprises a transport box control circuit in communication with said environment controlling means;
a delivery box having a locking front door and an interior space, said delivery box further including at least one transport box receptacle having means for establishing an electrical connection with the environment controlling means of a transport box received therein, wherein said locking front door comprises an electronic lock and a data input device disposed on the locking front door, said delivery box further includes a delivery box control circuit in communication with said data input device and said electronic lock; and
means for exchanging data between said delivery box control circuit and said transport box control circuit.

2. The system of claim 1, wherein said delivery box further comprises a second door accessing said interior space.

3. The system of claim 2, wherein said delivery box control circuit has a communication interface for sending and receiving data on the Internet.

4. The system of claim 1, wherein said transport box control circuit further comprises means for receiving data.

5. The system of claim 4, wherein said data includes delivery instructions.

6. The system of claim 5, wherein said transport box control circuit further comprises means for controlling said environment controlling means according to said delivery instructions.

7. The system of claim 1, wherein said transport box further comprises a GPS receiver in communication with said transport box control circuit.

8. The system of claim 1, wherein said delivery box further comprises a second door accessing said interior space, said delivery box control circuit has a communication interface for sending and receiving data on the Internet, and said data input device comprises a keycard reader configured so that a delivery person must swipe a keycard having an access code through the keycard reader to unlock the electronic lock.

9. The system of claim 8, wherein said data input device further comprises a wireless sensor configured so that the delivery person must further transmit a secondary access code to the wireless sensor to unlock the electronic lock.

10. The system of claim 9, further comprising a second lock mounted on said second door for selectively locking said second door.

11. The system of claim 10, further comprising a second wireless sensor in communication with said delivery box control circuit configured so that the user must transmit a user access code to the second wireless sensor to unlock the second lock.

12. The system of claim 11, further comprising a computer port in communication with said delivery box control circuit, the computer port being formed in said second door, the computer port being configured so that the user must further transmit a second user code to said delivery box control circuit via the computer port to unlock the second lock.

13. The system of claim 12, wherein said computer port is a universal serial bus port.
